(19) United States
(12) Patent Application Publication
(10) Pub. No.: US 2002/0129954 A1
(43) Pub. Date: Sep. 19, 2002

(54) Spring levers used for locating and preloading a PCB

(76) Inventor: Jeffrey A. Griffis, Redwood City, CA (US)

Correspondence Address: Bruce H. Johnsonbaugh, Eckhoff, Hoppe, Slick, Mitchell & Anderson, Suite 3125, 333 Market Street, San Francisco, CA, 94105, US

(21) Appl. No.: 09/810,198

(22) Filed: Mar. 15, 2001

(51) Int. Cl. H02G 3/08

(52) U.S. Cl. 174/50

(57) ABSTRACT

A method and apparatus are provided for mounting a printed circuit board (PCB) in an optoelectronic transceiver housing. The mounting technique is quick, easy and requires no secondary adhesive or hardware. The PCB is mounted into an injection molded plastic housing that is plated with a conductive material. In its mounted state, the PCB deflects a spring feature of the housing such that the PCB is located securely therein. The PCB is preloaded against the plated plastic in order to electrically connect the PCB ground to the chassis ground.

### CROSS-REFERENCE TO RELATED APPLICATION

This application is a continuation-in-part of U.S. patent application Ser. No. ______ titled “Optical Wavelength Division Multiplexer and/or Demultiplexer Mounted in a Pluggable Module,” filed on Mar. 12, 2001, and incorporated herein by reference.

### Background of the Invention

1. Field of the Invention

The present invention relates generally to techniques for mounting a printed circuit board (PCB) to a frame or housing and more specifically, it relates to a method for securely and reliably mounting a PCB to a housing without the need for secondary adhesives or fasteners.

2. Description of Related Art

There are many ways to mount a small PCB to a frame or housing. This is commonly done with adhesives or fasteners. However, Design for Assembly (DFA) and Design for Manufacturing (DFM) principles dictate that the number of parts and assembly steps should be reduced whenever possible.

It is desirable to provide a method by which a small PCB can be mounted to a frame or housing without the use of secondary adhesives or fasteners. It is also desirable if a method could be provided for attachment of a PCB that can maintain a constant preload between the PCB and a conductive housing for grounding purposes.

### SUMMARY OF THE INVENTION

It is an object of the present invention to provide a method by which a small PCB can be mounted to a frame or housing without the use of secondary adhesives or fasteners.

It is another object of the present invention to provide a method of attachment of a PCB to a conductive housing that can maintain a constant preload between the PCB and the conductive housing for grounding purposes.

These and other objects will be apparent to those skilled in the art based on the disclosure herein.

The invention is a method and apparatus for mounting a printed circuit board (PCB) in an optoelectronic transceiver housing. The mounting technique is quick, easy and requires no secondary adhesive or hardware. The PCB is mounted into an injection molded plastic housing that has been plated with a conductive material. In its mounted state, the PCB deflects a spring feature of the housing such that the PCB is located securely therein. The PCB is preloaded against the plated plastic in order to electrically connect the PCB ground to the chassis ground.

A general embodiment of the invention includes a nonmetallic housing containing a number of levers n that locate a PCB in the housing by clamping it with a force m against the nonmetallic housing. The nonmetallic housing may be partially or completely coated, plated or otherwise covered with a metallic substance with the purpose of establishing an electrical connection from the PCB ground to chassis ground.

### BRIEF DESCRIPTION OF THE DRAWINGS

FIG. 1 shows the printed circuit board positioned above the transceiver plastic housing in preparation for mounting.

FIG. 2 shows the details of the circled area of FIG. 1.

FIG. 3 shows the PCB inserted into the plastic housing.

### DETAILED DESCRIPTION OF THE INVENTION

In one form of the invention, a method and apparatus for mounting an optical transceiver PCB is provided that is quick, easy and requires no secondary adhesive or hardware. A nonmetallic housing comprises a number of levers to locate a PCB by clamping it against the nonmetallic housing, which may be partially or completely coated, plated or otherwise covered with a metallic substance with the purpose of establishing an electrical connection from the PCB ground to chassis ground.

The PCB is mounted into a copper/nickel plated injection molded plastic housing. The plastic housing is made of a GE Lexan® filled 10% by weight with glass. The mechanical properties of this Lexan® are consistent with the properties that are desirable for molding a spring feature directly in the plastic housing. In its mounted state, the PCB deflects the spring feature such that the PCB is located securely in the plastic housing. The PCB is preloaded against the plated plastic in order to electrically connect the PCB ground to the chassis ground.

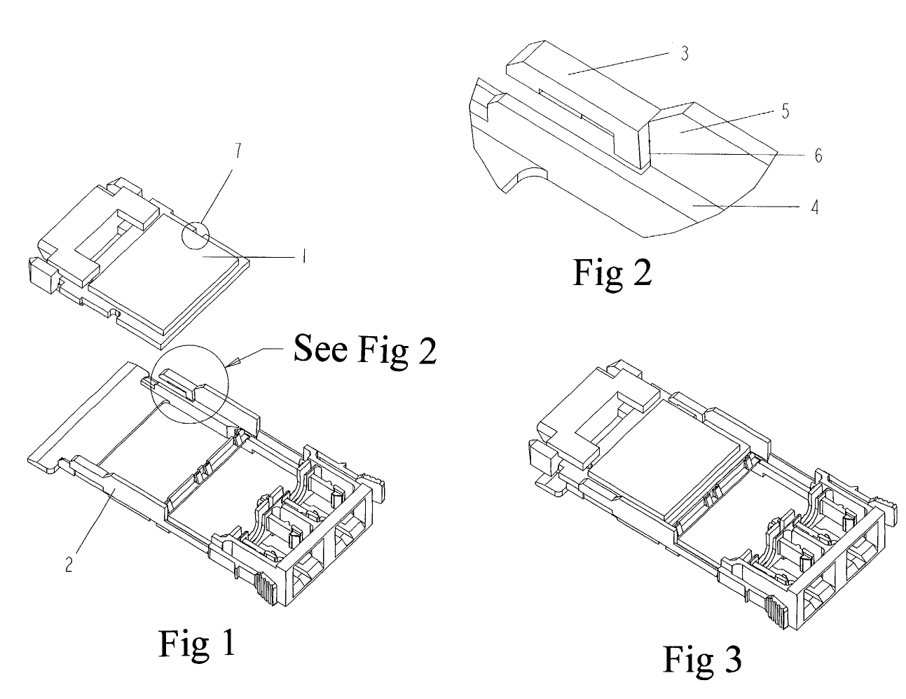

FIG. 1 shows the printed circuit board 1 positioned above the transceiver plastic housing 2. Printed circuit board (PCB) 1 includes recesses 7. The plastic housing 1 is a optoelectronic transceiver module, examples of which are described in commonly owned U.S. patent application Ser. No. ______, titled “Optical Wavelength Division Multiplexer and/or Demultiplexer Mounted in a Pluggable Module,” filed on Mar. 12, 2001, and incorporated herein by reference. Other examples of optoelectronic transceiver modules are described in commonly owned U.S. Pat. No. 6,201,908, titled “Optical Wavelength Division Multiplexer/Demultiplexer Having Preformed Passively Aligned Optics,” incorporated herein by reference. Still other optoelectronic transceiver modules are known in the art.

FIG. 2 shows the details of the circled area of FIG. 1. Transceiver plastic housing 2 includes plastic ledges 4. Walls 5 are connected to plastic ledges 4. At the end of the walls are located spring levers 3, which include plastic housing locating tabs 6. FIG. 3 shows the PCB inserted into the plastic housing.

The steps for mounting PCB 1 into transceiver plastic housing 2 can be understood with reference to FIGS. 1-3. The first step is shown in FIG. 1, where the printed circuit board is positioned above the transceiver plastic housing 2. PCB 1 is moved into position under spring levers 3 until locating tabs 6 lodge into PCB recesses 7. In its installed position, PCB 1 is preloaded by plastic housing spring levers 3 onto plastic housing ledges 4 and is located laterally by transceiver plastic housing walls 5. PCB 1 is located longitudinally by plastic housing locating tabs 6 lodging into PCB recesses 7.

The foregoing description of the invention has been presented for purposes of illustration and description and is not intended to be exhaustive or to limit the invention to the precise form disclosed. Many modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. An apparatus for mounting a printed circuit board, comprising a housing that has at least one lever for locating said PCB in said housing, wherein said at least one lever clamps said PCB with a force applied against said housing.

2. The apparatus of claim 1, wherein said at least one lever provides a positive pressure toward said housing.

3. The apparatus of claim 2, wherein said housing is nonmetallic.

4. The apparatus of claim 2, wherein said housing comprises an optoelectronic transceiver housing.

5. The apparatus of claim 2, further comprising housing comprises plastic.

6. The apparatus of claim 2, wherein said housing is injection molded.

7. The apparatus of claim 2, wherein said housing comprises Lexan®.

8. The apparatus of claim 7, wherein said Lexan® comprises about 10% glass.

9. The apparatus of claim 3, further comprising a covering of conducting material on at least a portion of said housing.

10. The apparatus of claim 9, wherein said conducting material comprises metal.

11. The apparatus of claim 2, wherein said PCB deflects said at least one lever such that said PCB is located securely in the plastic housing.

12. The apparatus of claim 9, wherein said PCB deflects said at least one lever such that said PCB is preloaded against said covering of conducting material, wherein said PCB is electrically connected to the chassis ground.

13. The apparatus of claim 10, wherein said metal is selected from the group consisting of copper and nickel.

14. The apparatus of claim 4, wherein said plastic housing comprises plastic ledges with walls connected thereto, wherein said walls comprise levers, wherein said levers comprises locating tabs.

15. The apparatus of claim 14, wherein said PCB comprises recesses, wherein said PCB is preloaded by said levers onto said ledges, wherein said PCB is located laterally by said walls, wherein said PCB is located longitudinally by said tabs lodging into said PCB recesses.
